(19) United States
(12) Patent Application Publication
(10) Pub. No.: US 2024/0126595 A1
(43) Pub. Date: Apr. 18, 2024

(54) METHOD AND APPARATUS FOR MANAGING A QUEUE AND QUEUE MANAGEMENT DEVICE

(71) Applicant: Cortina Access, Inc., San Jose, CA (US)

(72) Inventor: Te-Lung Huang, San Jose, CA (US)

(21) Appl. No.: 17/965,065

(22) Filed: Oct. 13, 2022

(51) Int. Cl. G06F 9/48; G06F 9/54

(52) U.S. Cl. CPC G06F 9/4881; G06F 9/544; G06F 9/546

(57) ABSTRACT

A method for managing a queue including a plurality of buffers is provided and includes the following steps: linking at least one of second buffers after each of a plurality of first buffers to form a plurality of sub-queues in a linked-list manner, wherein the buffers include the plurality of first buffers and the plurality of second buffers; linking the first buffers of the sub-queues to form the queue in the linked-list manner; separating a plurality of separated buffers, including a first one of the first buffers and the second buffers linked thereafter, from the queue by breaking a link between the first one of the first buffers and a second one of the first buffers; and releasing the separated buffers. An apparatus for managing the queue and a queue management device are also provided.

### BACKGROUND

### Technical Field

The disclosure relates to a data storage technology, in particular to a method and an apparatus for managing a queue and a queue management device.

### Related Art

A queue can be used to temporarily store data and provide a buffering function in data transmission. Sometimes, the queue needs to be flushed so that the system can reclaim storage space for use. The operation of flushing the queue means discarding data in buffers in the queue and returning the buffers to an empty state.

Generally speaking, the process of flushing a queue formed in a single-level linked-list manner cannot be interrupted, and includes the following operations: stop inputting data to the queue, stop outputting data from the queue, actually perform the flush operation (including aligning read and write pointers, resetting the related counter, reclaiming buffers into the buffer pool), and return the queue to the system. Therefore, when being flushed, the queue cannot be used normally for a period of time, which affects the execution efficiency of the system.

### SUMMARY

In view of this, an example of the disclosure provides a method for managing a queue comprising a plurality of buffers, the method including: linking at least one of second buffers after each of a plurality of first buffers to form a plurality of sub-queues in a linked-list manner, where the buffers include the plurality of first buffers and the plurality of second buffers; linking the first buffers of the sub-queues to form the queue in the linked-list manner; separating a plurality of separated buffers, including a first one of the first buffers and the second buffers linked thereafter, from the queue by breaking a link between the first one of the first buffers and a second one of the first buffers; and releasing the separated buffers.

An example of the disclosure further provides a queue management device, including: a memory circuit, an output circuit and a queue management circuit. The memory circuit includes a plurality of priority queues, and the priority queues correspond to a plurality of priorities. The output circuit is configured to enqueue data to a target queue in the priority queues and dequeue and output the data from the target queue. The queue management circuit is configured to link buffers in a linked-list manner to form at least one reduction queue in the priority queues. The buffers linked include a plurality of first buffers and a plurality of second buffers. At least one of the second buffers is linked after each of the first buffers. The queue management circuit is also configured to link the first buffers of the reduction queue in a linked-list manner, separate a plurality of separated buffers, including a first one of the first buffers and the second buffers linked thereafter, from the reduction queue by breaking a link between the first one of the first buffers and a second one of the first buffers, and release the separated buffers.

An example of the disclosure further provides an apparatus for managing a queue comprising a plurality of buffers. The apparatus including a queue management circuit, coupled to the buffers, and configured to link at least one of second buffers after each of a plurality of first buffers to form a plurality of sub-queues in a linked-list manner, wherein the buffers comprise the plurality of first buffers and the plurality of second buffers; link the first buffers of the sub-queues to form the queue in the linked-list manner; separate a plurality of separated buffers, comprising a first one of the first buffers and the at least one of the second buffers linked thereafter, from the queue by breaking a link between the first one of the first buffers and a second one of the first buffers; and release the separated buffers.

According to the method and the apparatus for managing a queue and the queue management device provided by the examples of the disclosure, part of the buffers of the queue (reduction queue) can be easily released. Besides, the queue (reduction queue) is flushed intermittently in sections, so that there is no need to flush the entire queue (reduction queue) at a same time. Therefore, the influence on the enqueue and dequeue functions of the queue (reduction queue) can be greatly reduced, and there is no need to interrupt the network packet forwarding operation.

### BRIEF DESCRIPTION OF THE DRAWINGS

FIG. 1 is a flowchart of a queue management method according to an example of the disclosure;

FIG. 2 is a schematic diagram of a first-level linked list according to an example of the disclosure;

FIG. 3 is a schematic diagram of a second-level linked list according to an example of the disclosure;

FIG. 4 is a schematic diagram showing separation of buffers from a queue according to an example of the disclosure; and

FIG. 5 is a schematic diagram showing an architecture of a queue management method applied to a packet forwarding device according to an example of the disclosure.

### DETAILED DESCRIPTION

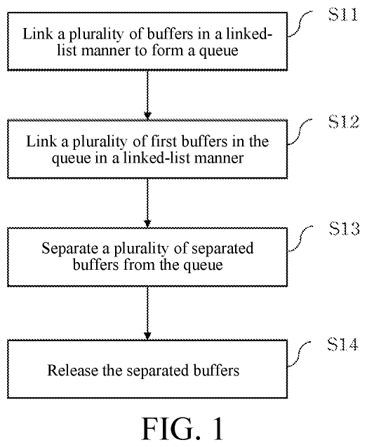

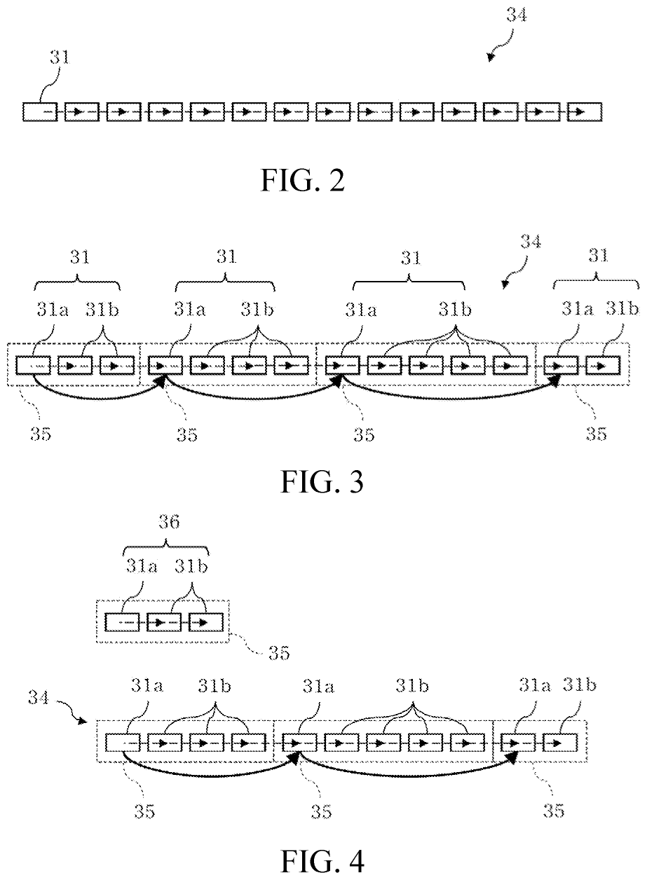

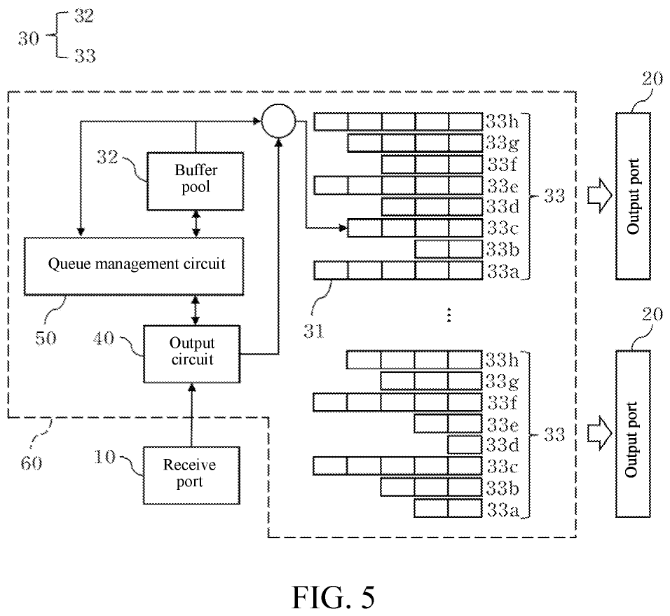

FIG. 1 is a flowchart of a queue management method according to an example of the disclosure, which is executed in a multilevel linked-list manner. The queue management method is executed by a queue management circuit 50 (as shown in FIG. 5). First, in step S1, a plurality of buffers 31 are linked in a linked-list manner to form a queue 34. FIG. 2 is a schematic diagram of a first-level linked list according to an example of the disclosure. The dotted arrows indicate the link relationship between the buffers 31. The buffer 31 is from a buffer pool 32 (as shown in FIG. 5). Specifically, the first-level linked list creates a log sheet (hereinafter referred to as the first sheet) used for recording address of the first one of the buffers 31 and address of the next buffer 31 linked to each of the buffers 31. Thereby, according to the first sheet, the buffers 31 in the queue 34 may be traversed one by one, so that data stored therein can be fetched (dequeued). In the dequeuing process, the data is fetched from the buffer 31 at the front end of the queue 34, the buffer 31 from which the data has been fetched is released, and the released buffer 31 is reclaimed into the buffer pool 32. Besides, when data is to be added (enqueued) to the queue 34, the first sheet is also used. Specifically, when data that can be stored in one buffer 31 needs to be added, an unused buffer 31 will be allocated from the buffer pool 32, the data is stored in this buffer 31, and this buffer 31 is linked to the rear end of the queue 34 in a linked-list manner.

In step S12, a part of the buffers 31 (hereinafter referred to as the first buffers 31a) of the queue 34 are linked in a linked-list manner. FIG. 3 is a schematic diagram of a second-level linked list according to an example of the disclosure. The solid arrows indicate the link relationship between the first buffers 31a. The second-level linked list creates another log sheet (hereinafter referred to as the second sheet) used for recording address of the first buffers 31a and address of the next first buffer 31a linked to each of the first buffers 31a. For convenience of description, the buffers 31 in the queue 34 other than the first buffers 31a will be referred to as the second buffers 31b. That is, the buffers 31 include a plurality of first buffers 31a and a plurality of second buffers 31b. In the first-level linked list, at least one of the second buffers 31b is linked after each of the first buffers 31a to form a plurality of sub-queues in a linked-list manner. The queue 34 is divided into a plurality of sections 35 (i.e., the sub-queues) based on the first buffers 31a, and each of the sections 35 (i.e., the sub-queues) includes one of the first buffers 31a and one or more of the second buffers 31b linked thereafter. According to the second sheet, the sections 35 (i.e., the sub-queues) in the queue 34 may be traversed one by one. Since the first sheet records the link relationship of the buffers 31 in each of the sections 35, the buffers 31 in the sections 35 can be traversed one by one according to the first sheet. In some examples, the first sheet does not record the link relationship between the last second buffer 31b of each section 35 and the first buffer 31a of the next section 35 in step S11. In some examples, each of the sections 35 is used for storing data of a network packet. That is, the length of each of the sections 35 is not fixed and depends on the size of the stored network packet.

After execution of steps S11 and S12, the queue 34 is obtained with a multi-level linked-list structure. For example, the queue 34 is obtained with a two-level linked-list structure.

In some examples, step S12 is performed before step S11.

In step S13, a plurality of buffers 31 (hereinafter referred to as separated buffers 36) are separated from the queue 34 by breaking a link between the first one of the first buffers 31a and a second one of the first buffers 31a, as shown in FIG. 4. FIG. 4 is a schematic diagram showing separation of buffers 31 from the queue 34 according to an example of the disclosure. The separated buffers 36 include the first one of the first buffers 31a and the second buffers 31b linked thereafter. In detail, the breaking the link between the first one of the first buffers 31a and the second one of the first buffers 31a includes: using the second sheet to find out the address of the second one of the first buffers 31a, updating the second sheet, and replacing this second one of the first buffer 31a with the first one of the first buffer 31a of the entire queue 34; and updating the first sheet, and replacing this second one of the first buffer 31a with the first one of the buffers 31 of the entire queue 34. The unseparated buffers 31 still form the queue 34, and the size of the queue 34 is changed accordingly. Before updating the first sheet, the link relationship corresponding to the separated buffers 36 in the first sheet is recorded.

In step S14, the separated buffers 36 are released by using the link relationship of the separated buffers 36 recorded in step S13. The separated buffers 36 are reclaimed into the buffer pool 32. It is to be noted here that in the process of separating the separated buffers 36 from the queue 34, the queue 34 suspends execution of enqueue and dequeue functions, and after the separated buffers 36 are separated from the queue 34, the queue 34 resumes the execution of the enqueue and dequeue functions. In the process of separating the separated buffers 36 from the queue 34, it is only required to find out the address of the second one of the first buffers 31a and update the first sheet and the second sheet, so this process only takes a short time, for example, 1-2 clock cycle time. As a result, the separated buffers 36 can be flushed to get released when appropriate (e.g., when there is no demand for dequeue). When steps S13 and S14 are repeated for many times, the separated buffers 36 can be released in sections for many times. After each execution of steps S13 and S14, the separated buffers 36 in one of the sections 35 will be released. In this way, the system can intermittently flush the queue 34 in sections, so that there is no need to flush the entire queue 34 at a same time. Therefore, the influence on the enqueue and dequeue functions of the queue 34 can be greatly reduced. Since the flushing in sections does not influence the functions of the queue 34, there is no need to stop data transmission due to the need for refreshing the queue 34. That is, the operation of refreshing the queue 34 can be hidden behind normal functionality of the queue 34.

In some examples, the first sheet also records the number of the buffers 31 in the queue 34, and the second sheet also records the number of the first buffers 31a in the queue 34. When refreshing the queue 34, the number of the buffers 31, the number of the first buffers 31a, the address of the first one of the buffers 31 and the address of the first one of the first buffers 31a will be updated.

FIG. 5 is a schematic diagram showing an architecture of a queue management method applied to a packet forwarding device according to an example of the disclosure. The packet forwarding device include at least one receive port 10, at least one output port 20 and a queue management device 60. The queue management device 60 includes a memory circuit 30, an output circuit 40 and a queue management circuit 50. The receive port 10 is configured to receive one or more packets. One receive port 10 and eight output ports 20 will be taken as an example. The memory circuit 30 includes a buffer pool 32 and a plurality of priority queues 33. The buffer pool 32 includes a plurality of buffers (not shown). The priority queues 33 correspond to at least one of the output ports 20. The priority queues 33 corresponding to the same output port 20 are respectively associated with different transmission priorities, and are used to temporarily store packets with different priority levels respectively. In FIG. 1, eight priority queues 33 are taken as an example, and they are numbered 33a-33h respectively according to their transmission priorities from high to low. The output circuit 40 is configured to enqueue data of each of the packets to a certain priority queue 33 (hereinafter referred to as the “target queue”) of a certain output port 20 (hereinafter referred to as the “target output port”), and dequeue and forward the enqueued packet data from the target queue.

In some examples, the target output port and the target queue are determined through information extracted from a packet header.

In some examples, the process of storing the packet into the target queue includes the following steps. First, a buffer 31 is allocated from the buffer pool 32. Next, packet data is stored in this buffer. Moreover, the target output port and the target queue of this packet are determined, such that the packet data is enqueued to the target queue of the target output port, that is, this buffer 31 is linked to the rear end of the target queue in a linked-list manner. After the packet data is stored in the target queue, the packet data can be dequeued according to an export schedule and output by the target output port. The packet forwarding device further includes an export scheduler (now shown) configured to execute the export schedule.

The queue management circuit 50 is configured to allocate a plurality of buffers 31 from the buffer pool 32 to each of the priority queues 33. When at least one of the priority queues (hereinafter referred to as the reduction queue) needs to reduce the number of the buffers 31, steps S13 and S14 of the queue management method described above are executed. After steps S13 and S14 are performed once, the buffers 31 in one of the sections 35 of the reduction queue are reclaimed. In some examples, each of the priority queues 33 is formed through steps S11 and S12 of the queue management method described above. In some examples, at least one of the reduction queues is formed through steps S11 and S12 of the queue management method described above.

As in the examples described above, in the process of separating the separated buffers 36 from the reduction queue, the reduction queue suspends execution of enqueue and dequeue functions, and after the separated buffers 36 are separated from the reduction queue, the reduction queue resumes the execution of the enqueue and dequeue functions.

In some examples, as in the examples described above, the reduction queue is divided into a plurality of sections 35 based on the first buffers 31a, and each of the sections 35 includes one of the first buffers 31a and one or more of the second buffers 31b linked thereafter. In some examples, each of the sections 35 is used for storing data of a network packet.

In some examples, the reduction queue has a lower priority level than the other priority queues.

In some examples, the queue management device 60 is applied to other devices other than the packet forwarding device, and can be used to temporarily store other types of data other than the network packet.

According to the method and the apparatus for managing the queue 34 and the queue management device 60 provided by the examples of the disclosure, part of the buffers 31 of the queue 34 (reduction queue) can be easily released. Besides, the queue 34 (reduction queue) is flushed intermittently in sections, so that there is no need to flush the entire queue 34 (reduction queue) at a same time. Therefore, the influence on the enqueue and dequeue functions of the queue 34 (reduction queue) can be greatly reduced, and there is no need to interrupt the network packet forwarding operation.

What is claimed is:

1. A method for managing a queue comprising a plurality of buffers, the method comprising:
linking at least one of second buffers after each of a plurality of first buffers to form a plurality of sub-queues in a linked-list manner, wherein the buffers comprise the plurality of first buffers and the plurality of second buffers;
linking the first buffers of the sub-queues to form the queue in the linked-list manner;
separating a plurality of separated buffers, comprising a first one of the first buffers and the at least one of the second buffers linked thereafter, from the queue by breaking a link between the first one of the first buffers and a second one of the first buffers; and
releasing the separated buffers.

2. The method according to claim 1, wherein in the process of separating the separated buffers from the queue, the queue suspends execution of enqueue and dequeue functions, and after the separated buffers are separated from the queue, the queue resumes the execution of the enqueue and dequeue functions.

3. The method according to claim 1, wherein the queue is divided into a plurality of sections based on the first buffers, each of the sections comprises one of the first buffers and the at least one of the second buffers linked thereafter, and each of the sections is configured to store a network packet.

4. The method according to claim 1, applicable to at least one reduction queue in a plurality of priority queues, wherein the at least one reduction queue is the queue and has a lower priority level than the other priority queues.

5. The method according to claim 1, wherein the queue is a multi-level linked-list structure.

6. The method according to claim 1, wherein the queue is a two-layer linked list structure.

7. The method according to claim 1, wherein the unseparated buffers still form the queue, and the size of the queue is changed accordingly.

8. A queue management device, comprising:
a memory circuit, comprising a plurality of priority queues, wherein the priority queues correspond to a plurality of priorities;
an output circuit, configured to enqueue data to a target queue in the priority queues and dequeue and output the data from the target queue; and
a queue management circuit, configured to link buffers in a linked-list manner to form at least one reduction queue in the priority queues, the buffers linked comprising a plurality of first buffers and a plurality of second buffers, and at least one of the second buffers being linked after each of the first buffers; and also configured to link the first buffers of the reduction queue in a linked-list manner, separate a plurality of separated buffers, comprising a first one of the first buffers and the at least one of the second buffers linked thereafter, from the reduction queue by breaking a link between the first one of the first buffers and a second one of the first buffers, and release the separated buffers.

9. The queue management device according to claim 8, wherein in the process of separating the separated buffers from the reduction queue, the reduction queue suspends execution of enqueue and dequeue functions, and after the separated buffers are separated from the reduction queue, the reduction queue resumes the execution of the enqueue and dequeue functions.

10. The queue management device according to claim 8, wherein the reduction queue is divided into a plurality of sections based on the first buffers, each of the sections comprises one of the first buffers and the at least one of the second buffers linked thereafter, and each of the sections is configured to store a network packet.

11. The queue management device according to claim 8, wherein the reduction queue has a lower priority level than the other priority queues.

12. The queue management device according to claim 8, wherein the queue is a multi-level linked-list structure.

13. The queue management device according to claim 8, wherein the queue is a two-layer linked list structure.

14. The queue management device according to claim 8, wherein the unseparated buffers still form the queue, and the size of the queue is changed accordingly.

15. An apparatus for managing a queue comprising a plurality of buffers, the apparatus comprising:
a queue management circuit, coupled to the buffers, and configured to
link at least one of second buffers after each of a plurality of first buffers to form a plurality of sub-queues in a linked-list manner, wherein the buffers comprise the plurality of first buffers and the plurality of second buffers;
link the first buffers of the sub-queues to form the queue in the linked-list manner;
separate a plurality of separated buffers, comprising a first one of the first buffers and the at least one of the second buffers linked thereafter, from the queue by breaking a link between the first one of the first buffers and a second one of the first buffers; and
release the separated buffers.

16. The apparatus according to claim 15, wherein the queue is divided into a plurality of sections based on the first buffers, each of the sections comprises one of the first buffers and the at least one of the second buffers linked thereafter, and each of the sections is configured to store a network packet.

17. The apparatus according to claim 15, wherein the queue is a multi-level linked-list structure.

18. The apparatus according to claim 15, wherein the queue is a two-layer linked list structure.

19. The apparatus according to claim 15, wherein the unseparated buffers still form the queue, and the size of the queue is changed accordingly.
